(19) United States
(12) Patent Application Publication
(10) Pub. No.: US 2004/0063370 A1
(43) Pub. Date: Apr. 1, 2004

(54) Abrasive sheet for texturing and method of producing same

(75) Inventors: Norio Makiyama, Kurashiki-city (JP); Munechika Yamamoto, Osaka-city (JP); Yukio Goto, Osaka-city (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Co., Ltd., Kurashiki-city (JP)

(21) Appl. No.: 10/662,509

(22) Filed: Sep. 16, 2003

Related U.S. Application Data
(63) Continuation of application No. 09/880,116, filed on Jun. 14, 2001.

(30) Foreign Application Priority Data
Jun. 19, 2000 (JP) 2000-182998

(51) Int. Cl. B32B 33/00; D04H 5/00

(52) U.S. Cl. 442/363; 442/361; 442/341; 442/340; 428/85; 428/91

(57) ABSTRACT

An abrasive sheet for texturing of magnetic recording media which comprises an entangled ultrafine fiber nonwoven fabric made of three-dimensionally entangled ultrafine fiber bundles composed of ultrafine fibers (A) and a high-molecular elastomer occurring in a porous state in spaces among the entangled ultrafine fibers, with the high-molecular elastomer occurring therein without substantially confining most of the ultrafine fiber bundles and which is characterized in that there is a nap consisting of ultrafine fibers (B) having a fineness of not more than 0.03 dtex on at least one side of that sheet is excellent in precision and stability in processing.

### BACKGROUND OF THE INVENTION

1. Field of the Invention

The present invention relates to an abrasive sheet which can be used in texturing in the production of magnetic recording media, for example magnetic disks. More particularly, it relates to an abrasive sheet for texturing of magnetic recording media which makes it possible to provide a fine texture in a stable manner.

2. Description of the Prior Art

Capacity increasing or size reduction of magnetic recording media is one of the major factors enabling the production of higher-performance and smaller-size computers, which is a current trend. As an example of the technologies that have enabled the production of such computers, thin film magnetic disks whose recording layer is a thin magnetic film layer laid on a nonmagnetic disk substrate utilizing the sputtering technique, for instance, are now mounted, as magnetic recording media to be combined with magnetic heads, on large-capacity hard disk systems and the like owing to their high information recording density. They are widely employed and in common use also as magnetic recording media not only in business computers but also in computers for general household use, namely personal computers, in parallel with the recent demand expansion in the digital information field and with the recent price reduction in the field of digital information processing apparatus.

The common process for producing thin film magnetic disks includes, as an important step, a step called texturing step in which a desired pattern of groove-like fine unevenness, namely texture, is formed on the nonmagnetic disk substrate surface (thin magnetic film-supporting surface) prior to the thin magnetic film formation on the nonmagnetic disk substrates. The purpose of texturing the thin magnetic film-supporting surface is to form uniform and fine unevenness on the thin film magnetic disk surface via a layer, such as a thin magnetic film, laid on the thin film-supporting surface to thereby produce such effects as (1) the effect of preventing disk surface damages due to head crash (phenomenon of a magnetic head whose flying height has been made as small as possible hand in hand with the improvement in information recording density colliding against protrusions occurring on the disk surface) or sticking of a magnetic head to the disk surface (phenomenon of a magnetic head remaining sticking to the disk surface and failing to fly due to an insufficiency of running torque resulting, among others, from spindle motor size reduction in parallel with the size reduction of hard disk systems), for instance, and (2) the effect of increasing the coercive force in the direction of recording as a result of controlling the directionality of crystal growth in the step of forming a metallic magnetic layer on the disk substrate with a nonmagnetic layer formed thereon.

For improving the information recording density of magnetic disks which are being developed with increasing speed or reducing the size of hard disk systems, it is essential to make finer the texture created on the disk surface, namely stably improve the precision of the mean surface roughness (hereinafter sometimes referred to also as “Ra” for short) which corresponds the mean depth of projections or depressions, for the purpose of improving the stability of continuous information recording/reproduction operation or prevention of head crash or magnetic head sticking, for instance, in CSS (contact start and stop) operation.

The abrasive sheets in conventional use for texturing are abrasive sheets of the immobilized abrasive particle type as produced by forming an abrasive layer composed of abrasive particles and a binder on the sheet substrate surface such as the PET (polyethylene terephthalate) film surface, and abrasive sheets of the free abrasive particle type for carrying out the texturing treatment using a suspension of abrasive particles dispersed in an aqueous solution or the like as free or unimmobilized abrasive particles (hereinafter such suspension is referred to as “abrasive suspension” or “abrasive liquid” for short), among others.

Such immobilized abrasive particle type abrasive sheets for texturing are disadvantageous in that the friction of abrasive particles with the disk substrate surface is strong and, in addition, abrasion dust accumulated at the interface between the disk and abrasive sheet can hardly be cleaned out, hence the dust may readily develop serious flaws, although they are excellent in abrasion rate per unit time, namely in processing speed.

With the free abrasive particle type, the removability of abrasion dust can readily be increased and, further, the abrasive particles can freely migrate from the surface to the inside and from the inside to the surface of the abrasive sheet with a liquid serving as a medium, so that the friction with the disk substrate surface can be readily adjusted as compared with the immobilized abrasive particle type. Furthermore, since the results of processing can be readily influenced directly by the change of abrasive sheet material, various grinding tapes made of a flocked cloth or woven or knitted cloth have been proposed and have been used properly according to the purpose of processing.

For improving the precision of processing in texturing, it is necessary to adjust the friction with the disk substrate surface via abrasive particles to an optimal level. Thus, the method utilizing a nonwoven fabric, for instance, as a base material has attracted attention in recent years owing to its being structurally superior in cushioning property and surface smoothness and various proposals have so far been made. Among others, various proposals have been made to make finer the fineness of fibers constituting the nonwoven fabric for the purpose of improving the abrasive sheet surface smoothness or adjusting the friction against the disk substrate surface. Thus, for example, JP Kokai H09-277175 proposes an abrasive sheet produced by napping by grinding of the surface of an entangled nonwoven fabric made of ultrafine fibers not more than 10 μm in diameter and JP Kokai H10-188272 proposes an abrasive tape made of fibers not more than 0.1 denier (about 0.11 dtex) in fineness. Further, in JP Kokai H11-144241, there is proposed a texturing tape produced by bonding a nonhydrophilic random web to the back of a random web made of hydrophilic fibers not more than 0.5 denier (about 0.55 dtex) in fineness; in processing using this texturing tape, a surface roughness of about Ra=13.7 Å (1.37 nm) is realizable.

According to each of these proposals, the sheet or tape is constituted of a nonwoven fabric alone, which consists of ultrafine fibers having a fineness of about 0.1 dtex, and only the random structure of nonwoven fabrics and/or such fiber-determined properties as fineness and hydrophilicity/hydrophobicity are utilized. Therefore, the precision of texturing is confined to the level of Ra≧1 nm, presumably due to insufficient mobility, or aggregation of abrasive particles as resulting from insufficient affinity between free abrasive particles and abrasive sheet, or due to uneven disposition of fibers as caused by insufficient immobilization of fibers acting on the abrasive sheet surface and, if the sheet or tape is used at such a processing precision level, the rate of processing per unit number of disks cannot be increased. The sheet or tape is thus unsatisfactory in industrial practicing at such a level of processing precision as aimed at by the present inventors.

Examples of the free abrasive particle type abrasive sheet are described in JP Kokai H11-90836 and JP Kokai H11-99478 in which examples a binder component, such as a thermoplastic resin, is incorporated in the nonwoven fabric structure for bundling and fixing fibers. Thus, the abrasive cloth proposed in JP Kokai H11-90836 comprises a nonwoven fabric made of synthetic fibers and a thermoplastic resin comprising components in the same composition as the fibers as contained therein for firmly bonding fibers. In JP Kokai H11-99478, there is proposed an abrasive pad comprising a nonwoven fabric in which heat-fused fibers and non-heat-fused fibers are intermingled and which is impregnated with a high-molecular elastomeric polymer such as polyurethane. However, both inventions are directed to abrasive cloths suited for mirror surface polishing of the disk substrate surface, which is carried out in a step prior to the step of texturing in which the abrasive sheet of the invention is to be used, or for mirror surface polishing of the semiconductor wafer surface. Basically, the abrasive sheet surface is prevented from deforming by making hard the abrasive sheet structure itself and the friction of abrasive particles with the target of abrasion is increased so that the processing precision in mirror surface polishing can be improved. In the proposal to expose a resin on the abrasive sheet surface, the formation of abrasion dust from the abrasive sheet itself is suppressed by selecting the hardness of the resin itself at a high level. Therefore, as a matter of course, such abrasive sheet, when used in texturing, shows an excessively high friction, so that texture formation cannot be realized at the desired processing precision level; the abrasive sheet is thus basically unsuited for the solution of the problem to be solved by the present invention.

As mentioned above, the prior art abrasion sheets for texturing have not yet realized such texturing treatment as achieving a processing precision at a level of Ra≦1 nm as expressed in terms of surface roughness and, at the same time, showing stability in industrial use, namely such texturing treatment as balanced between processing precision and rate of processing per unit number of disks.

### SUMMARY OF THE INVENTION

The present invention, which has been made in view of the problems discussed above, has it for its object to provide an abrasive sheet for texturing of magnetic recording media with which a fine texture with a mean surface roughness of a level not more than 1 nm, for instance, can be provided uniformly and stably in the texturing treatment in the production of magnetic recording media, for example magnetic disks, since it does not cause any large damages on the disk substrate surface.

The present invention provides an abrasive sheet for texturing of magnetic recording media which comprises an entangled ultrafine fiber nonwoven fabric made of three-dimensionally entangled ultrafine fiber bundles composed of ultrafine fibers (A) and a high-molecular elastomer occurring in a porous state in spaces among the entangled ultrafine fibers, with the high-molecular elastomer occurring therein without substantially confining most of the ultrafine fiber bundles and which is characterized in that there is a nap consisting of ultrafine fibers (B) having a fineness of not more than 0.03 dtex on at least one side of that sheet. The high-molecular elastomer in the above abrasive sheet preferably has a wet elastic modulus of 0.05 to 0.95 kg/mm² and the ultrafine fibers (A) and ultrafine fibers (B) in the above abrasive sheet both are preferably ultrafine polyamide or polyester fibers.

The invention also provides a method of producing abrasive sheets for texturing of magnetic recording media which comprises carrying out the following steps (1) to (4) in that order [in which the order of the steps (2) and (3) may be reversed]:

(1) the step of forming a nonwoven fabric mainly composed of ultrafine fiber-generating fibers (a), which are capable of generating ultrafine fiber bundles upon treatment for generating the same, and ultrafine fiber-generating fibers (b), which are capable of generating bundles of ultrafine fibers not more than 0.03 dtex in fineness upon treatment for generating the same and constitute the nonwoven fabric surface layer portion to provide a nap,

(2) the step of converting the nonwoven fabric to a sheet by filling with a high-molecular elastomer,

(3) the step of converting the ultrafine fiber-generating fibers (a) and (b) to ultrafine fiber bundles, respectively, and

(4) the step of forming a nap consisting of ultrafine fibers not more than 0.03 dtex in fineness by grinding at least one side of the sheet.

### DETAILED DESCRIPTION OF THE PREFERRED EMBODIMENT

In the following, the present invention is described in detail.

As the magnetic recording media substrate to be used in the practice of the invention, there may be mentioned, for example, those disk-like substrates made of an aluminum alloy which are in conventional use. The substrate, which has a predetermined size, is processed to a predetermined thickness, the surface thereof is mirror-finished and a nonmagnetic layer having a thickness of about 5 to 20 μm is formed thereon, for example by electroless plating of a nonmagnetic metal such as a Ni—P alloy or a Ni—Cu—P alloy.

The texturing in the practice of the invention is a treatment well known in the art which provide the disk surface having the nonmagnetic layer formed in the above manner with a texture, which is a predetermined striated pattern, at a desired level of precision. This treatment comprises at least a stage at which the abrasive sheet is pressed against the disk substrate surface via a suspension containing a predetermined amount of abrasive particles in free form (hereinafter such suspension is sometimes referred to as “abrasive liquid” or “suspension for abrasion”) to thereby effect the grinding treatment. Thus, the texturing may be carried out by merely pressing the abrasive sheet against the nonmagnetic disk surface via the abrasive liquid to thereby provide a texture with a desired precision, or by performing rough grinding using an abrasive sheet having immobilized abrasive particles to thereby provide a texture and then pressing the abrasive sheet against the disk surface via the abrasive liquid to selectively finish defective sites such as burrs and/or flashes and thereby attain a desired level of precision. The texturing apparatus may be of the type using the abrasive sheet of the invention as an abrasive pad and pressing the same against the disk substrate surface in a face-to-face manner or of the type using the abrasive sheet of the invention as an endless tape for abrasion and pressing the same against the disk substrate surface linearly. These types of apparatus may be used singly or in combination.

By using the abrasive sheet of the invention for texturing of magnetic recording media in the above texturing, it becomes possible to stably provide the magnetic disk substrate surface or the like with a texture in a very fine processing precision range, for example in a mean surface roughness range at a level of Ra≦1 nm. Such a precision range cannot have been realized yet on a commercial scale for the reason that the processing precision cannot be balanced against the rate of processing per unit number of disks or for other reasons.

The desired processing precision in the texturing according to the invention can be attained by using the abrasive sheet of the invention and, in addition, appropriately adjusting the texturing conditions such as the conditions for preparing the suspension for abrasion containing free abrasive particles, in particular the abrasive particle size and/or free abrasive particle concentration, the viscosity of the abrasive liquid, the processing apparatus operating conditions, in particular the disk peripheral velocity (number of revolutions), the rate of feeding or the number of reciprocations (oscillation frequency) of the abrasive sheet, the cylinder pressure, the time of pressing of the abrasive sheet per unit disk.

After the above texturing, a substrate or undercoat layer having a thickness of about 1 to 20 nm is formed on the disk substrate surface by sputtering of Cr or the like and a metallic magnetic layer having a thickness of about 5 to 100 nm is formed on the substrate layer by sputtering of a Co-based alloy or the like. Further, a carbonaceous film having a thickness of about 1 to 50 nm is formed on the metallic magnetic layer generally by sputtering of diamond, graphitic or amorphous carbon used as the target in an atmosphere of a noble gas, such as argon or helium. In this way, thin film magnetic disks to be mounted on large-capacity hard disk systems and the like are produced.

Now, the process for producing the abrasive sheet of the invention for texturing of magnetic recording media is described in detail.

The abrasive sheet of the invention for texturing of magnetic recording media can be produced by carrying out at least the four steps (1) to (4) mentioned above in that order. The steps (2) and (3) may be performed in the reversed order if the invention can be embodied. Further, a step or steps of providing one or more of various treatment agents or additives, such as hydrophilicity providing agents, water repellents, softening agents, antistatic agents, ultraviolet absorbers, flame retardants or fire retardants, antimicrobial agents, lubricants, and colorants such as dyes and pigments, may be added among the steps (1) to (4) or before or after them.

The ultrafine fiber-generating fibers (a) to be used in the above step (1) are fibers capable of generating ultrafine fiber bundles composed of ultrafine fibers (A) upon physical treatment or chemical treatment, for instance. The ultrafine fiber-generating fibers (b) to be used in the same step (1) are fibers capable of generating ultrafine fiber bundles composed of ultrafine fibers (B) having a fineness of not more than 0.03 dtex upon the same treatment as mentioned above. The physical treatment includes, among others, needle punching treatment, fluid flow treatment such as high-speed water flow treatment, calendering and other compressing treatment with heating and mechanical crumpling and the chemical treatment includes, among others, treatment for partial fiber constituent removal using a removing agent and treatment for fiber constituent swelling and separating .

In the practice of the invention, the ultrafine fiber-generating fibers (a) may be the same as or different from the ultrafine fiber-generating fibers (b). From the ease of production viewpoint, it is desirable to use the same fibers as the ultrafine fiber-generating fibers (a) and ultrafine fiber-generating fibers (b) so that the ultrafine fibers (A) and ultrafine fibers (B) constituting the abrasive sheet may be the same.

As preferred examples of the ultrafine fiber-generating fibers (a) and ultrafine fiber-generating fibers (b) to be used in the practice of the invention, there may be mentioned the so-called separable type composite fibers composed of two or three or more fiber-forming resins and mutually disposing the plurality of fiber-forming constituent resins so as to enable separation into the respective fiber-forming constituent resins upon the above-mentioned physical or chemical treatment by controlling, for example, the mutual adhesiveness of the fiber-forming constituent resins at an appropriate level, the so-called sea-island type fibers comprising a fiber-forming resin removable with a removing or eliminating agent, which resin is used as a dispersion medium component, and a hardly removable fiber-forming resin used as a dispersed phase component and disposed in the manner of islands, and other ultrafine fiber-generating fibers known in the art.

Among them, sea-island type fibers make it possible to form spaces among the ultrafine fiber bundles and the high-molecular elastomer by removing the dispersion medium component (sea component) after providing the nonwoven fabric with the high-molecular elastomer and thus make it possible to meet the essential requirement to be satisfied in the practice of the invention that the high-molecular elastomer should be caused to exist without substantially confining most of the ultrafine fiber bundles. Therefore, it is judicious to use sea-island type fibers in the practice of the invention. The hardly removable fiber-forming constituent resin (island component) in the sea-island type fibers need not be composed of a single fiber-forming resin species but may be composed of two or more fiber-forming resin species. Each fiber-forming constituent resin in the ultrafine fiber-generating fibers (a) and (b) may be continuous in the longitudinal direction or may occur in an intermittent state.

As the method of causing the high-molecular elastomer to exist without substantially confining most of the ultrafine fiber bundles, there is available, in addition to the method which comprises using sea-island type fibers as the ultrafine fiber-generating fibers and removing the sea component from these fibers to thereby generate ultrafine fiber bundles made of the island component, as mentioned above, the method which comprises providing the nonwoven fabric with a water-soluble resin, typically polyvinyl alcohol, and, after impregnation with and coagulation of the high-molecular elastomer, removing the water-soluble resin. By using the latter method, it is also possible to produce a structure such that the ultrafine fiber bundles are substantially free from confinement by the high-molecular elastomer.

As the removing agent to be used in chemical treatment, there may be mentioned, among others, solvents, enzymes and microorganisms. Among them, solvents such as organic solvents and aqueous solvents show high removing rates and can be handled with ease, hence are judiciously used.

In the abrasive sheet of the invention, the nap-constituting ultrafine fibers (B) are required to have a fineness of not more than 0.03 dtex, preferably not more than 0.02 dtex, most preferably not more than 0.01 dtex. Although the lower limit is not particular restricted, it is preferably not less than 0.0001 dtex from the ease of production viewpoint. When the nap-constituting ultrafine fibers (B) have a fineness of not more than about 0.1 dtex, the napped portion shows sufficiently high smoothness and compactness, hence the texturing can be carried out at a processing precision of Ra≦1 nm, which is the target of the invention for the time being. When, however, the fineness is in excess of 0.03 dtex, a tendency is observable toward marked impairment in processing precision with the increasing number of disks processed, presumably due to somewhat stronger friction against the disk substrate surface. The fineness rendering the processing precision hardly dependent on the number of disks processed in a processing precision range of Ra≦1 nm, which is the target of the invention for the time being, is not more than 0.03 dtex. In the section to the depth of about ⅓ in the direction of thickness from the napped surface of the abrasive sheet of the invention, the ultrafine fibers (A) constituting the portions other than the napped portions preferably have a fineness of not more than 0.1 dtex, more preferably the same fineness as the nap-constituting fibers, namely 0.0001 to 0.03 dtex. When the fineness of ultrafine fibers (A) in the section to the depth of at least about ⅓ in the direction of thickness from the napped surface is in excess of 0.1 dtex, the nonwoven fabric surface smoothness, hence the abrasive sheet smoothness, becomes insufficient and, further, the friction against the disk substrate surface in the step of texturing becomes excessively strong, hence the processing precision lowers. In a preferred embodiment of the invention, substantially all ultrafine fiber bundles constituting the nonwoven fabric from the front to the reverse side thereof are composed of ultrafine fibers having a fineness of not more than 0.1 dtex. In a more preferred embodiment, the bundles are formed of ultrafine fibers having a fineness of not more than 0.03 dtex.

The fineness of ultrafine fibers (A) or ultrafine fibers (B) constituting the abrasive sheet of the invention is the so-called mean fineness calculated from the fiber density and the mean fiber sectional area as calculated for fibers in ultrafine fiber bundles selected arbitrarily at 10 sites in the vicinity of the root of the nap and in the section down to about ⅓ in the direction of thickness from the napped surface on an observation surface prepared by cutting the abrasive sheet at an angle of 30 to 60 degrees to the direction of thickness and observed under a scanning electron microscope (SEM). In the abrasion sheet of the invention, the requirement that the fineness should be not more than 0.03 dtex should be satisfied at least by the napped portions, and these portions should be substantially free of ultrafine fiber bundles with a mean fineness exceeding 0.03 dtex as calculated in the above manner for ultrafine fiber bundles observed under a SEM. The portions which should satisfy the preferred condition that the fineness should be not more than 0.1 dtex occur to the depth of at least about ⅓ from the napped side (front surface) in the direction of thickness and, preferably, those portions are substantially free of any ultrafine fiber bundles exceeding 0.1 dtex in the mean fineness calculated in the above manner for ultrafine fiber bundles observed under a SEM.

As the resin constituting the above-mentioned ultrafine fiber-generating fibers, there may be mentioned the combination of two or more fiber-forming resins capable of forming fibers and capable of generating ultrafine fibers upon physical or chemical treatment. Thus, for example, polyamides such as nylon 6, nylon 66, nylon 610, nylon 12 and polyamide copolymers; polyesters such as polyethylene terephthalate, polypropylene terephthalate, polybutylene terephthalate and polyethylene terephthalate-based copolymers; polyolefins such as polyethylene, polypropylene and polymethylpentene; polyacrylonitriles; vinyl polymers such as polystyrene and polyvinyl chloride; aliphatic polyester polymers such as polylactic acid, lactic acid copolymers and polyglycolic acid; aliphatic polyester amide copolymers and the like may be mentioned as synthetic resins usable as fiber constituents.

Among the fiber-forming resins listed above, polyamides, which have abrasion resistance and hydrophilicity, namely an equilibrium water content of not less than 1.0% as measured at a relative humidity of 65%, and polyesters, which are excellent in strength, abrasion resistance and elasticity, may be mentioned as preferred examples of the ultrafine fiber constituent. When these are used, the abrasion resistance and good strength and elasticity of the fiber-forming resin constituents can be expected to be effective in improving the durability in processing treatment of the resulting abrasive sheet, and the hydrophilicity of the fiber-forming resin constituents can be expected to be effective in making it difficult for the abrasive particles in the aqueous slurry preferably used as the suspension for abrasion containing abrasive particles in free state to aggregate, or in providing the resulting abrasive sheet with a function to allow abrasive particles to migrate smoothly from the abrasive sheet surface to the inside thereof, for instance, and thus preventing the disk substrate surface from being severely damaged. The polyamides mentioned above, for example nylon 6, nylon 66, nylon 610 and nylon 12, are particularly preferred.

The above ultrafine fiber-generating fibers to be used in the practice of the invention can be readily spun by the conjugate spinning method, mixed spinning method or an appropriate combination of these. One or more of such additives as hydrophilicity providing agents, flame retardants or fire retardants, antistatic agents, moisture absorbers, conductive agents, and colorants such as pigments and dyes can be incorporated in the fiber-forming resins each in appropriate amount unless the spinnability, fiber strength, geometry and function of the resulting abrasive sheet are decreased or impaired.

Preferred, among others, as the method of forming a nonwoven fabric from ultrafine fiber-generating fibers (a) and (b) in the above step (1) is the method which comprises forming a fibrous web consisting of the above-mentioned ultrafine fiber-generating fibers by carding, for instance, laying a plurality of such webs one over another to attain a desired basis weight and then entangling fibers three-dimensionally with one another within the whole web by a known treatment such as needle punching or treatment by means of the action of a liquid flow, such as a water flow. At the stage of forming a fibrous web or layering a plurality of fibrous webs, ultrafine fiber-generating fibers of a different type or a fibrous web made thereof may be joined or, when ultrafine fiber-generating fibers capable of generating ultrafine fibers exceeding 0.03 dtex in fineness are contained, the three-dimensional entangling treatment is preferably carried out under conditions such that those fibers can be prevented from being substantially exposed on at least one side of the nonwoven fabric (the side to be napped). When the nonwoven fabric is produced from two or more different ultrafine fiber-generating fibers, at least the surface to be napped should be substantially covered with ultrafine fiber-generating fibers capable of generating only ultrafine fibers with a fineness of not more than 0.03 dtex even if the fineness of ultrafine fibers capable of being generated is not more than 0.1 dtex. In a more preferred embodiment, that surface of the nonwoven fabric which is to be napped comprises only one ultrafine fiber-generating fiber species.

In accordance with the invention, it is essential that the nonwoven fabric is an entangled one, as mentioned above. Even when a composite sheet with a high-molecular elastomer is formed in the same manner as in the practice of the invention using a woven or knit fabric in lieu of the nonwoven fabric and the composite sheet is used as an abrasive sheet, such a processing precision as aimed at by the present invention can never be attained, since the smoothness of abrasive sheets is determined by the structure of the woven fabric itself, not by the fineness of ultrafine fibers. On the contrary, by using such a nonwoven fabric structure comprising fibers having random orientations as in the present invention, it is possible to form abrasive sheets having smoothness making use of the fineness of ultrafine fibers. Further, the bulky structure of the nonwoven fabric comprising ultrafine fibers three-dimensionally entangled shows itself cushioning properties in response to the hardness of fibers and/or the state of entanglement, so that it is possible to control the friction of the abrasive sheet formed therefrom against the disk substrate surface via abrasive particles contained in the suspension for abrasion.

Further, as mentioned hereinbefore, by providing, where necessary, the nonwoven fabric with a water-soluble resin, typically polyvinyl alcohol, by impregnation or coating, to cover the surface of most of nonwoven fabric-constituting fibers with the water-soluble resin and thereby allow the water-soluble resin to occur between the high-molecular elastomer provided in a later step and the fibers and removing, by washing with water, that water-soluble resin at an appropriate stage after provision of the high-molecular elastomer, it is possible to obtain an abrasive sheet in a state such that the high-molecular elastomer occurs surrounding the nonwoven fabric-constituting ultrafine fiber bundles but most of the ultrafine fiber bundles are not substantially confined by the high-molecular elastomer. The method using such water-soluble resin is very effective when the order of the steps (2) and (3) mentioned above is reversed. In this case, the step of providing the water-soluble resin may be conducted at any time point after formation of ultrafine fiber-generating fibers and before the step (2).

In the above step (1), a nonwoven fabric is formed from ultrafine fiber-generating fibers and, in the above step (2), the nonwoven fabric is provided with a high-molecular elastomer to give a sheet. In accordance with the invention, the high-molecular elastomer is caused to be contained in the nonwoven fabric structure in expectation of the effects of preventing the abrasive sheet-constituting ultrafine fibers from falling away and improving the affinity thereof for the suspension for abrasion. The effect of preventing the ultrafine fibers from falling away is mainly due to the frictional resistance which can result from the state such that the high-molecular elastomer does not confine directly the ultrafine fiber bundles forming a three-dimensionally entangled structure but surrounds the ultrafine fiber bundles whereas the other effect of improving the affinity thereof for the suspension for abrasion is mainly due to the increase in suspension absorption which can be realized by the porous state in which the high-molecular elastomer itself is and the occurrence of minute spaces among the ultrafine fiber bundles and the high-molecular elastomer. In texturing, the abrasive sheet itself is also ground, for example by abrasive particles occurring in the suspension for abrasion and, therefore, when the nonwoven fabric structure contains a high-molecular elastomer, the production of abrasion dust may excessively increase under certain processing conditions as compared with the use of an abrasive sheet comprising a nonwoven fabric structure alone and thus the rate of processing per unit number of disks cannot be increased in some instances. In accordance with the invention, however, the abrasive sheet can be rendered industrially utilizable by giving it a structure showing improved affinity for the suspension and thereby allowing abrasive particles or abrasion dust to migrate smoothly from the surface to the inside of the abrasive sheet, as mentioned above, and, more preferably, by using a high-molecular elastomer having a wet elastic modulus of 0.05 to 0.95 kg/mm² as the elastomer and thereby maximally preventing excessive abrasion by abrasive particles.

As the high-molecular elastomer to be used in the above step (2), there may be mentioned, among others, polyurethanes and modifications thereof obtained by reacting at least one polymer diol selected from among polyester diols, polyether diols, polycarbonate diols, polyester polyether diols and the like, at least one diisocyanate selected from among aromatic, alicyclic and aliphatic diisocyanates such as 4,4′-diphenylmethanediisocyanate, isophoronediisocyanate and hexamethylene diisocyanate and at least one low-molecular compound selected from among diols having at least two active hydrogen atoms, such as ethylene glycol and hexanediol, diamines such as ethylenediamine and isophoronediamine and the like in a predetermined mole ratio. In addition to such polyurethanes and modifications thereof, polyester elastomers and acrylic elastomers having a wet elastic modulus of 0.05 to 0.95 kg/mm², for instance, may also be used as the high-molecular elastomer in the above step (2). Elastomer compositions resulting from blending these may also be used. Considering the elastic recovery and porous state formability, etc., however, the use of such polyurethanes as mentioned above is most preferred in the practice of the invention.

The high-molecular elastomer to be used in accordance with the invention has a wet elastic modulus of 0.05 to 0.95 kg/mm², more preferably 0.08 to 0.50 kg/mm². When the wet elastic modulus of elasticity is less than 0.05 kg/mm², the strength of the elastomer as one member participating in the structure construction in the abrasive sheet becomes insufficient, hence an elastomer having such a wet elastic modulus is not suited for use in the practice of the invention. When the wet elastic modulus is greater than 0.95 kg/mm², the cushioning properties of the abrasive sheet become insufficient for the use of the sheet in texturing and the effect of preventing ultrafine fibers in the abrasive sheet from falling away also unfavorably lowers.

As examples of the polyurethane which can satisfy the adequate requirement that the wet elastic modulus should be 0.05 to 0.95 kg/mm², there may be mentioned, among others, polyurethanes produced by using, in the polyurethane production example mentioned above, one or a plurality of polymer diol species having a number average molecular weight of 700 to 2,500 and one or a plurality of diisocyanates in a mole ratio of 1/1.5 to 1/5 and using ethylene glycol or ethylenediamine as a chain extender. Polyurethanes obtained by using a main component polymer diol having a number average molecular weight less than 700 or reacting a polymer diol and a diisocyanate in a more diisocyanate-rich mole ratio than 1/5 tend to show a wet elastic modulus exceeding 0.95 kg/mm² while polyurethanes obtained by using a main component polymer diol having a number average molecular weight exceeding 2,500 or reacting a polymer diol and a diisocyanate in a more polymer diol-rich mole ratio than 1/1.5 tend to show a wet elastic modulus lower than 0.05 kg/mm². Even under conditions outside those mentioned above, it is also possible, however, to produce polyurethanes satisfying the above wet elastic modulus requirement by carrying out the reaction in multiple stages or combinedly using a plurality of polymer diols differing in kind or in molecular weight or introducing a compound having a specific stereostructure into the polyurethane structure, for instance. Therefore, the above polyurethane production example is just an example of the mode of practice satisfying the above requirement prescribed according to the invention.

The wet elastic modulus so referred to herein is the value according to the definition in JIS K 6301-1995 (low stretching stress test) as measured in a wet state after immersing the test specimen in water at 30° C. for 30 minutes. The purpose of the test is to understand the properties of the high-molecular elastomer in a state mimicking the supposed state of an abrasive sheet acting on the disk substrate surface via an abrasive particle-containing suspension for abrasion.

In the above step (2), the nonwoven fabric is provided with the above high-molecular elastomer to give a sheet. Usable as the elastomer providing method is, for example, the dry coagulation method comprising impregnating or coating the nonwoven fabric with a high-molecular elastomer-containing liquid prepared by dispersing or dissolving the high-molecular elastomer in a solvent or the like and then drying by heating to thereby cause coagulation in a porous state or the wet coagulation method comprising immersing the nonwoven fabric impregnated with the high-molecular elastomer-containing liquid in a nonsolvent-containing liquid to thereby cause coagulation of the high-molecular elastomer in a porous state, whereby a sheet is obtained with the high-molecular elastomer occurring in a porous state in the entangled fiber structure in the nonwoven fabric. The wet coagulation method is judiciously used among others, since it is superior in controllability in giving a desirable porous state to the high-molecular elastomer in the practice of the invention.

In the above high-molecular elastomer-containing liquid, there may be incorporated, when necessary, one or more of additives such as colorants, coagulation modifiers, antioxidants, dispersants and blowing agents. The proportion of the high-molecular elastomer in the abrasive sheet of the invention for texturing of magnetic recording media is selected within the range of 10 to 70% by weight, preferably 20 to 55% by weight, so that the abrasive sheet can be provided with a sufficient level of elastic recovery and a highly smooth surface state can be created. As the method of controlling the weight proportion, there may be mentioned the method comprising appropriately selecting the concentration of the high-molecular elastomer-containing liquid, the weight of the high-molecular elastomer-containing liquid to be consumed for impregnation relative to the nonwoven fabric weight and other factors. In the preferred mode of practice of the invention, a high-molecular elastomer-containing liquid having a concentration of about 5 to 30% is used and the impregnation is carried out in the manner of spontaneous penetration or in a forced manner utilizing the compressing effect produced by a bar, knife, roll or like means, or utilizing both manners of impregnation. Further, if necessary, a further step of removing the excess high-molecular elastomer-containing liquid adhering to the nonwoven fabric by pressing a bar, knife, roll or like means against the same is added. When the proportion of the high-molecular elastomer in the abrasive sheet is less than 10%, such a porous state as required in the practice of the invention is hardly be produced. When the proportion of the high-molecular elastomer in the abrasive sheet is above 70%, a state such that ultrafine fibers are exposed abundantly on the abrasive sheet surface is hardly obtained. Therefore, it is not judicious to select such a proportion.

As the method of converting the sheet-constituting, three-dimensionally entangled, ultrafine fiber-generating fibers to ultrafine fiber bundles in the above step (3), there may be mentioned, for example, the method comprising removing the component to be removed by using a chemical or agent capable of serving as a nonsolvent against the fiber component which is to give ultrafine fibers and against the high-molecular elastomer but serving as a solvent or decomposing agent against the component of ultrafine fiber-generating fibers which is to be removed, the chemical treatment method such as the method comprising partly reducing the amount of the ultrafine fiber component by means of a solvent or decomposing agent or the like capable of dissolving or decomposing the ultrafine fiber component itself, the compression treatment method such as calender treatment with heating, the entanglement treatment method using a needle punching machine or a liquid flow, and the physical treatment method such as the mechanical crumpling method. Among them, the method comprising using the sea-island type fibers mentioned hereinbefore as ultrafine fiber-generating fibers and removing the sea component by means of a solvent or the like to thereby cause the island component to remain as ultrafine fibers and form ultrafine fiber bundles is judiciously employed for the reasons, among others, that ultrafine fibers not more than 0.1 dtex in fineness can readily and stably obtained by that method and that, when the steps (2) and (3) are carried out in that order, a state in which the majority of ultrafine fibers are not substantially confined by the high-molecular elastomer can be attained with good efficiency.

As the method of grinding the sheet surface in the above step (4), there may be mentioned those methods known in the art, such as slicing treatment using a band knife and grinding treatment using a sandpaper. By performing these either singly or in appropriate combination, it is possible to form a nap consisting of ultrafine fibers on at least one side of the sheet and, at the same time, attain the desired sheet thickness and surface smoothness of the abrasive sheet and, furthermore, the effect of converting those ultrafine fiber-generating fibers to ultrafine fiber bundles which have failed to form ultrafine fiber bundles to a satisfactory extent in the above step (3) and other effects can also be expected. The thickness appropriate for the abrasive sheet of the invention is preferably within the range of 0.2 to 1.5 mm considering the smoothness and cushioning properties as an abrasive sheet, the shape-retaining properties, the mountability on texturing apparatus and so forth. The apparent density appropriate for the abrasive sheet of the invention is preferably within the range of 0.2 to 0.6 g/cm³ in view of the ease of migration of abrasive particles in the suspension for abrasion from the surface to the inside of the abrasive sheet, the smoothness and cushioning properties of the abrasive sheet itself, the handling properties thereof in texturing and other factors. During or after the above steps (3) to (4), a step of providing one or more of softening agents, flame retardants or fire retardants, lubricants, hydrophilicity providing agents, water repellents, antistatic agents, ultraviolet absorbers, colorants and organic solvents by a method known in the art, such as coating or impregnation may be added according to need unless the shape and functions as the abrasive sheet of the invention are impaired.

As mentioned above, the abrasive sheet of the invention for texturing can be produced by carrying out the above steps (1) to (4) in that order or by reversing the order of the steps (2) and (3), coating the ultrafine fiber-generating fibers with a water-soluble resin prior to the step (3) and removing that water-soluble resin after the step (2).

The abrasive sheet obtained in accordance with the invention, when used in texturing in the process of manufacturing magnetic recording media, for example magnetic disks, can provide the disk substrate surface with a uniform and fine texture without severely damaging the same and, further, makes it possible to industrially realize texturing in a processing precision range, which has been difficult to attain in the prior art, by improving the affinity for the suspension for abrasion.

The following specific examples illustrate the present invention. They are, however, by no means limitative of the scope of the invention. In the examples of the invention and the comparative examples, the measured values were determined by the following measurement methods.

Thickness [mm]: The sheet was placed on a metal plate having a diameter of not less than 5 cm, a metal disk having a diameter of 1 cm was placed on the sheet, a load of 240 g f/cm² was applied thereto from the 1-cm-diameter metal disk side, the sheet thickness was measured at 10 sites and the mean of the 10 measured values was reported as the thickness.

Apparent density [g/cm³]: A 10-cm-square specimen was cut from the abrasive sheet and the thickness thereof was measured in the above manner and, thereafter, the weight was measured. The apparent density was calculated by dividing the weight by the volume of the sample. Wet elastic modulus [kg/mm²]: According to JIS K 6301-1995, a strip-like high-molecular elastomer sample (in nonporous form), 10 mm wide×60 mm long×100 μm thick, was immersed in water at 30° C. for 30 minutes, then taken out and, after immediate light wiping, set on a stretch stress tester (chuck-to-chuck distance: 20 mm) and preliminarily stretched under the following conditions: rate of pulling (returning): 45 mm/min, distance of pulling: 22.5% of chuck-to-chuck distance before stretching, two pullings each followed by returning after 30 seconds of standstill in the stretched state. Thereafter, the sample was lightly wiped with a wet cloth and subjected to the third stretching: rate of pulling: 45 mm/min, distance of pulling: 15% of mark-to-mark distance. After allowing the sample to stand in the stretched state for 30 seconds, the load was read. The wet elastic modulus was calculated by dividing this load value by the sectional area of the sample (in dry state). Mean surface roughness [nm]: According to JIS B 0601-1994, the disk substrate sample was measured for arithmetic mean roughness at 10 surface sites on an arbitrarily selected line. The mean of the values measured at the 10 sites was reported as the mean surface roughness (Ra).

### EXAMPLE 1

50% by weight of nylon 6 (Ny6) with an equilibrium moisture content of 3.5% was used as the island component and 50% by weight of low-density polyethylene (LDPE) was used as the sea component. They were mixed and melt-spun by the so-called mixed spinning method at 290° C. into sea-island type fibers. Ultrafine fiber-generating fibers with about 600 islands of the Ny6 component disposed in the LDPE component were thus obtained. The ultrafine fiber-generating fibers were stretched in warm water, mechanically crimped and cut to 51 mm. The resulting staples were carded and made into fibrous webs by the crosslapping method and then the fibrous webs were laid on one another, followed by needle punching and pressing on a calender roll to give a smooth-surface nonwoven fabric. This nonwoven fabric was impregnated with a 13% solution, in dimethylformamide (DMF), of a polycarbonate-based polyurethane with a wet elastic modulus of 0.42 kg/mm² as produced by reacting a mixed polymer diol mainly comprising polyhexamethylene carbonate diol with a number average molecular weight of 2000 with 4,4′-diphenylmethanediisocyanate in a mole ratio of 1/2.5, together with ethylene glycol (EG) and, then, the high-molecular elastomer was coagulated by immersing in a DMF/water mixture (wet coagulation method), whereby a sheet containing the high-molecular elastomer in a porous state was formed. The sea component polymer was removed from the ultrafine fiber-generating fibers using perchlene to give ultrafine fiber bundles. The resulting sheet was ground on both sides to give an abrasive sheet for texturing with a thickness of 0.55 mm and an apparent density of 0.34 g/cm³. In this abrasive sheet, the napped ultrafine fibers and the ultrafine fibers occurring within the sheet both had a fineness of 0.004 dtex and the weight proportion of the high-molecular elastomer was 36%. Most of the ultrafine fiber bundles were in a state free from confinement by the high-molecular elastomer.

Using this abrasive sheet, together with a slurry containing diamond particles having a mean particle size of 0.3 μm as free abrasive particles as the abrasion liquid, a total of 30 aluminum/nickel disk substrate surfaces were textured. After texturing, three disk substrates were sampled at random and evaluated for mean surface roughness (Ra). The Ra values were 0.4 nm, 0.4 nm and 0.5 nm, respectively, and it could be established that the roughness was stably about 0.4 nm, namely the order of not more than 1.0 nm was fully attained. After texturing, the abrasive sheet surface was washed and evaluated for surface condition under a scanning electron microscope (SEM). The surface was still in a state fully allowing the use of the sheet for the same processing, although the grinding by abrasive particles, among others, had progressed as compared with the state before use.

### EXAMPLE 2

Using 50% by weight of a nylon 6-nylon 12 copolymer having an equilibrium moisture content of 1.2% and a higher melt viscosity as compared with Example 1 as the island component and 50% by weight of LDPE as the sea component, ultrafine fiber-generating fibers with about 300 islands of the copolymer nylon disposed in the LDPE component were obtained by the mixed spinning method. An abrasive sheet for texturing with a thickness of 1.18 mm and an apparent density of 0.39 g/cm³ was obtained in the same manner as in Example 1 except that the above ultrafine fiber-generating fibers were used and that a polyether-based polyurethane with a wet elastic modulus of 0.23 kg/mm² as produced by multistepwise reacting a mixed polymer diol mainly comprising polytetramethylene ether glycol having a number average molecular weight of 2000 with MDI in a mole ratio of 1/0.7 and then reacting with MDI in a mole ratio of 1/3.4 relative to the starting mixed polymer diol and with EG was used as the high-molecular elastomer. In this abrasive sheet, the napped ultrafine fibers and the ultrafine fibers occurring within the sheet both had a fineness of 0.01 dtex and the weight proportion of the high-molecular elastomer was 45%. Most of the ultrafine fiber bundles were free from confinement by the high-molecular elastomer.

Using the abrasive sheet obtained, texturing was carried out in the same manner as in Example 1 and then three disk substrates sampled at random were evaluated for Ra. The Ra values were 0.6 nm, 0.6 nm and 0.7 nm, respectively, and it could be established that the roughness was stably about 0.6 nm, namely the order of not more than 1.0 nm was fully attained. The abrasive sheet was evaluated for surface condition and it was found that the sheet was still in a fully usable state as in Example 1.

### EXAMPLE 3

Using 50% by weight of polyethylene terephthalate (PET) as the island component and 50% by weight of LDPE as the sea component, ultrafine fiber-generating fibers with about 200 islands of the PET component disposed in the LDPE component were obtained by the mixed spinning method. An abrasive sheet for texturing with a thickness of 0.37 mm and an apparent density of 0.51 g/cm³ was obtained in the same manner as in Example 1 except that the above ultrafine fiber-generating fibers were used. In this abrasive sheet, the napped ultrafine fibers and the ultrafine fibers occurring within the sheet both had a fineness of 0.02 dtex and the weight proportion of the high-molecular elastomer was 24%. Most of the ultrafine fiber bundles were in a state free from confinement by the high-molecular elastomer.

Using the abrasive sheet obtained, texturing was carried out in the same manner as in Example 1 and then three disk substrates sampled at random were evaluated for Ra. The Ra values were 0.7 nm, 0.7 nm and 0.8 nm, respectively, and it could be established that the roughness was stably about 0.7 nm, namely the order of not more than 1.0 nm was fully attained. The abrasive sheet was evaluated for surface condition and it was found that there was little change in condition as compared with the condition prior to use. Naturally, it was still in a fully usable condition.

### EXAMPLE 4

Using 40% by weight of Ny6 having an equilibrium moisture content of 3.5% and a lower melt viscosity as compared with Example 1 as the island component and 60% by weight of LDPE as the sea component, ultrafine fiber-generating fibers (b) with about 4500 islands of the Ny6 component disposed in the LDPE component were obtained by the mixed spinning method. Separately, ultrafine fiber-generating fibers (a) were obtained in quite the same manner as in Example 1. Fibrous webs (a) and fibrous webs (b) separately formed from the ultrafine fiber-generating fibers (a) and ultrafine fiber-generating fibers (b), respectively, in the same manner as in Example 1 were laid on one another in a basis weight ratio of 1:2, followed by needle punching from the side of the fibrous webs (b) alone and further followed by pressing on a calender roll, whereby a smooth-surface nonwoven fabric with the above two kinds of fibers occurring separately in two layers and with the ultrafine fiber-generating fibers (a) being absent on the surface of the layer formed from the ultrafine fiber-generating fibers (b) was obtained. An abrasive sheet for texturing with a thickness of 0.79 mm and an apparent density of 0.38 g/cm³ was obtained by conducting the subsequent steps in the same manner as in Example 1 except that the polyether-based polyurethane produced in Example 2 and having a wet elastic modulus of 0.23 kg/mm² was used. In this abrasive sheet, the ultrafine fibers occurring from the napped surface to the depth of ½ of the thickness had a fineness of 0.0003 dtex and, in the remaining portion, ultrafine fibers having a fineness of 0.0003 dtex and ultrafine fibers having a fineness of 0.004 dtex occurred in a mixed state. The weight proportion of the high-molecular elastomer was 34%. Most of the ultrafine fiber bundles were in a state free from confinement by the high-molecular elastomer.

Using the thus-obtained abrasive sheet with the surface having a nap comprising 0.0003 dtex ultrafine fibers generated from the ultrafine fiber-generating fibers (b) as the front surface, texturing was carried out in the same manner as in Example 1. Then, three disk substrates sampled at random were evaluated for Ra. The Ra values were 0.4 nm, 0.5 nm and 0.5 nm, respectively, and it could be established that the roughness was stably about 0.5 nm, namely the order of not more than 1.0 nm was fully attained. The abrasive sheet was evaluated for surface condition and it was found that the sheet was still in a fully usable state as in Example 1.

### Comparative Example 1

Using 50% by weight of Ny6 as the island component and 50% by weight of LDPE as the sea component, ultrafine fiber-generating fibers with about 50 islands of the Ny6 component disposed in the LDPE component were obtained by the conjugate spinning method. An abrasive sheet for texturing with a thickness of 0.68 mm and an apparent density of 0.46 g/cm³ was obtained in the same manner as in Example 1 except that the above ultrafine fiber-generating fibers were used and that the polyether-based polyurethane of Example 2 was used as the high-molecular elastomer. In this abrasive sheet, the ultrafine fibers had a fineness of 0.08 dtex and the weight proportion of the high-molecular elastomer was 50%. Most of the ultrafine fiber bundles were in a state free from confinement by the high-molecular elastomer.

Using the napped sheet obtained as an abrasive sheet, texturing was carried out in the same manner as in Example 1 and then three disk substrates sampled at random were evaluated for Ra. The Ra values were 0.9 nm, 1.0 nm and 1.2 nm, respectively, with a mean value of about 1.0 nm, hence were stable. However, there were some disks showing an Ra value exceeding 1.0 nm and therefore it could not be said that the order of not more than 1.0 nm was stably attained. The abrasive sheet was evaluated for surface condition and it was found that it was in a fully usable condition as in Example 1.

### Comparative Example 2

Using 50% by weight of PET as the island component and 50% by weight of LDPE as the sea component, ultrafine fiber-generating fibers with about 16 islands of the PET component disposed in the LDPE component were obtained by the conjugate spinning method. An abrasive sheet for texturing with a thickness of 0.47 mm and an apparent density of 0.41 g/cm³ was obtained by forming a nonwoven fabric using these ultrafine fiber-generating fibers in the same manner as in Example 1, removing the LDPE component in the ultrafine fiber-generating fibers with perchlene, causing the polycarbonate-based polyurethane of Example 1 to be contained therein as the high-molecular elastomer in a porous state and further grinding both the surfaces. In this abrasive sheet, the ultrafine fibers had a fineness of 0.2 dtex and the weight proportion of the high-molecular elastomer was 21%. Most of the ultrafine fiber bundles were in a state free from confinement by the high-molecular elastomer.

Using the napped sheet obtained as an abrasive sheet, texturing was carried out in the same manner as in Example 1 and then three disk substrates sampled at random were evaluated for Ra. The Ra values were 1.7 nm, 1.8 nm and 1.8 nm, respectively, and were stably around 1.8 nm. It could thus be confirmed that the order of not more than 1.0 nm was unattainable. The abrasive sheet was evaluated for surface condition and it was found that a large amount of abrasion dust was adhering and therefore the sheet was not in a position to be used for such texturing as requiring the same level of precision, although the grinding by abrasive particles and the like had not progressed as compared with the sheet before processing.

### Comparative Example 3

A napped sheet with a thickness of 0.56 mm and an apparent density of 0.45 g/cm³ was obtained in the same manner as in Example 1 except that the step of providing the nonwoven fabric with the high-molecular elastomer was omitted. In this napped sheet, ultrafine fiber bundles composed of ultrafine fibers with a fineness of 0.004 dtex were in a three-dimensionally entangled state.

Using the napped sheet obtained as an abrasive sheet, texturing was carried out in the same manner as in Example 1 and then three disk substrates sampled at random were evaluated for Ra. The Ra values were 0.7 nm, 0.8 nm and 1.4 nm, respectively, with a mean value of about 1.0 nm. However, there were some disks showing an Ra value exceeding 1.0 nm and a tendency was observed toward significant roughening in Ra with the increasing number of disks treated. Therefore it could not be said that the order of not more than 1.0 nm was stably attained. Further, the abrasive sheet was evaluated for surface condition and it was found that the grinding by abrasive particles and the like had progressed as compared with the sheet before processing and the adhesion of abrasion dust was remarkable, hence the sheet was not in a position to be used for such texturing as requiring the same level of precision.

TABLE 1

| | | | | | Comparative | Comparative | Comparative |
|---|---|---|---|---|---|---|---|
| | Example 1 | Example 2 | Example 3 | Example 4 | Example 1 | Example 2 | Example 3 |
| Fineness [dtex] | 0.004 | 0.01 | 0.02 | 0.0003/ | 0.08 | 0.2 | 0.004 |
| | | | | 0.004 | | | |
| Wet elastic modulus | 0.42 | 0.23 | 0.42 | 0.23 | 0.23 | 0.42 | — |
| [kg/mm²] | | | | | | | |
| Thickness [mm] | 0.55 | 1.18 | 0.37 | 0.79 | 0.68 | 0.47 | 0.56 |
| Apparent specific | 0.34 | 0.39 | 0.51 | 0.38 | 0.46 | 0.41 | 0.45 |
| gravity [g/cm³] | | | | | | | |
| High-molecular | 36 | 45 | 24 | 34 | 50 | 21 | 0 |
| elastomer | | | | | | | |
| proportion [%] | | | | | | | |
| Mean surface | 0.4/0.4/ | 0.6/0.6/ | 0.7/0.7/ | 0.4/0.5/ | 0.9/1.0/ | 1.7/1.8/ | 0.7/0.8/ |
| roughness Ra [nm] | 0.5 | 0.7 | 0.8 | 0.5 | 1.2 | 1.8 | 1.4 |
| (n = 3) | | | | | | | |
| Abrasive tape | ◯ | ◯ | ⊚ | ◯ | ◯ | X | X |
| surface condition | | | | | | | |

### Effects of the Invention

The abrasive sheet for texturing as obtained according to the invention is composed of a nonwoven fabric structure mainly comprising ultrafine fibers and a high-molecular elastomer in a porous state. It further comprises spaces provided among ultrafine fiber bundles and the high-molecular elastomer and has, on the surface thereof, a nap consisting of ultrafine fibers having a fineness of not more than 0.03 dtex. Therefore, it, as a sheet structure, is very excellent in affinity for the suspension for abrasion and excellent in surface smoothness and cushioning properties. Furthermore, since the nap consisting of ultrafine fibers and occurring on the surface can control the friction of abrasive particles occurring in the suspension for abrasion against the substrate to be abraded to a desired level, the sheet can be utilized as an abrasive sheet for texturing where a very high level of processing precision of not more than 1.0 nm as expressed in terms of Ra, for instance, is required.

What is claimed is:

1. An abrasive sheet for texturing of magnetic recording media which comprises an entangled ultrafine fiber nonwoven fabric made of three-dimensionally entangled ultrafine fiber bundles composed of ultrafine fibers (A) and a high-molecular elastomer occurring in a porous state in spaces among the entangled ultrafine fibers, with the high-molecular elastomer occurring therein without substantially confining most of the ultrafine fiber bundles and which is characterized in that there is a nap consisting of ultrafine fibers (B) having a fineness of not more than 0.03 dtex on at least one side of that sheet.

2. An abrasive sheet as claimed in claim 1, wherein the high-molecular elastomer has a wet elastic modulus of 0.05 to 0.95 kg/mm².

3. An abrasive sheet as claimed in claim 2, wherein the high-molecular elastomer is a polyurethane produced by using one or a plurality of polymer diol species having a number average molecular weight of 700 to 2500 and a diisocyanate in a mole ratio of 1/1.5 to 1/5 and using ethylene glycol or ethylenediamine as a chain extender.

4. An abrasive sheet as claimed in claim 1, wherein the ultrafine fibers (A) and ultrafine fibers (B) are made of a polyamide or polyester.

5. An abrasive sheet as claimed in claim 1, wherein the ultrafine fibers (A) and ultrafine fibers (B) are both made of a polyamide.

6. An abrasive sheet as claimed in claim 1, wherein the ultrafine fibers (A) and ultrafine fibers (B) are of the same species.

7. An abrasive sheet as claimed in claim 1, wherein the ultrafine fibers (B) have a fineness of not more than 0.01 dtex.

8. An abrasive sheet as claimed in claim 1 which has a thickness of 0.2 to 1.5 mm.

9. An abrasive sheet as claimed in claim 1 which has an apparent density within the range of 0.2 to 0.6 g/cm³.

10. An abrasive sheet as claimed in claim 1, wherein the proportion of the high-molecular elastomer in the abrasive sheet is within the range of 10 to 70% by weight.

11. A method of producing abrasive sheets for texturing of magnetic recording media which comprises carrying out the following steps (1) to (4) in that order [wherein the order of the steps (2) and (3) may be reversed, however]:
(1) the step of forming a nonwoven fabric mainly composed of ultrafine fiber-generating fibers (a), which are capable of generating ultrafine fiber bundles upon treatment for generating the same, and ultrafine fiber-generating fibers (b), which are capable of generating bundles of ultrafine fibers not more than 0.03 dtex in fineness upon treatment for generating the same and constitute the nonwoven fabric surface layer portion to provide a nap,
(2) the step of converting the nonwoven fabric to a sheet by filling or impregnating with a high-molecular elastomer,
(3) the step of converting the ultrafine fiber-generating fibers (a) and (b) to ultrafine fiber bundles, respectively, and
(4) the step of forming a nap consisting of ultrafine fibers not more than 0.03 dtex in fineness by grinding at least one side of the sheet.

12. A method of production as claimed in claim 11, wherein the ultrafine fiber-generating fibers (a) and ultrafine fiber-generating fibers (b) are the same sea-island type fibers.

13. A method of production as claimed in claim 11, wherein the order of steps (2) and (3) is reversed and wherein the nonwoven fabric is provided with a water-soluble resin, typically polyvinyl alcohol, prior to the step (3) and the water-soluble resin is removed after the step (2).

14. A method of production as claimed in claim 11, wherein the method of filling the nonwoven fabric with the high-molecular elastomer comprises impregnating the nonwoven fabric with a solution of the high-molecular elastomer and then coagulating the elastomer by the wet method.
